(19) United States
(12) Patent Application Publication
(10) Pub. No.: US 2015/0302211 A1
(43) Pub. Date: Oct. 22, 2015

(54) REMOVABLE STORAGE MEDIUM SECURITY SYSTEM AND METHOD THEREOF

(71) Applicants: Tai hyo Kim, (US); Formal Works Inc., Seoul (KR)

(72) Inventor: Tai hyo Kim, Seoul (KR)

(21) Appl. No.: 14/423,700

(22) PCT Filed: Aug. 23, 2013
(86) PCT No.: PCT/KR2013/007600

§ 371 Date: Feb. 24, 2015

(30) Foreign Application Priority Data
Aug. 24, 2012 (KR) 10-2012-0092857

(51) Int. Cl. G06F 21/60; G06F 3/0484

(52) U.S. Cl. CPC G06F 21/604; G06F 3/04842

(57) ABSTRACT

A mobile storage medium safety system and method is disclosed. The mobile storage medium safety system provided at a host includes a file manager module for recognizing at least one file stored in a mobile storage medium when the mobile storage medium is connected to the host and a control unit for mounting on the host only a selective file selected by a predetermined method from at least one file recognized through the file manager module.

### TECHNICAL FIELD

The present invention relates to a removable storage medium security system and method, and more particularly, to a removable storage medium security system and method able to select only some of files stored in a removable storage medium to be mounted to a host when the removable storage medium is connected to the host, thereby preventing the host from being attacked by malicious files stored in the removable storage medium.

### BACKGROUND ART

Removable storage media (e.g. a universal serial bus (USB) data storage medium) are widely used in a variety of fields due to the convenience thereof. However, when such removable storage media are used, there are problems with security. In particular, it is known that a variety of viruses spread through removable storage media. Even in the situation in which networks are unavailable, virus infection through removable storage media may spread due to the carelessness of users, thereby leading to a fatal result, the impairment of security systems.

Because of such danger, a variety of security solutions for removable storage media are known and used.

Security for removable storage media of the related art generally includes a method of preventing information stored in a host from being disclosed through a removable storage medium and a method of preventing malicious information stored in the removable storage medium from being transferred to the host.

The former method employs input/output (IO) access control in order to prevent new data from being written on the removable storage medium. For example, a scheme of mounting the removable storage medium to the host with read-only authority is possible. However, this scheme has a limited ability to protect the host. Since the host can read data stored in the removable storage medium, it is impossible to protect against malicious files (e.g. a worm virus) in the removable storage medium that is already infected.

According to the latter method, when the removable storage medium is connected to and is subsequently mounted to the host, the mounted removable storage is used after being inspected using a solution of the related art, such as an antivirus program. Although this method has a positive effect on protection against known viruses, this method cannot protect against unknown viruses, which is problematic. In particular, since some malicious codes designed to attack a separate network (e.g. a supervisory control and data acquisition (SCADA) network) isolated from the external network may have different characteristics from those of widely spread viruses, it is very difficult to detect such malicious codes using common antivirus solutions, which is problematic.

As above, the related-art security methods for removable storage media have a limited ability to protect hosts to which removable storage media are connected. In case of some systems isolated from the external network, such as a nuclear power plant or a national backbone network, system update or periodic maintenance must be performed using a removable storage medium, such as a USB storage medium. Therefore, it is very important to safely protect a host to which the removable storage medium is connected. In fact, this is supported by the case in which Iranian nuclear facilities were damaged by the Stuxnet worm virus that attacked through the USB storage medium.

Accordingly, there is a need for a security technology that is safer and more securely protects a host than related-art technologies when a removable storage medium is connected to the host.

### DETAILED DESCRIPTION

### Technical Problem

Technical features of the present invention provide a system and method able to selectively allow only a safe file selected from files stored in a removable storage medium to be mounted to a host instead of allowing the removable storage medium itself to be mounted to the host when the removable storage medium is connected to the host, thereby preventing the host from being affected by any file except for the selected files.

### Technical Solution

According to an aspect of the present invention, provided is a removable storage medium security system provided in a host including: a file manager module recognizing one or more files stored in a removable storage medium when the removable storage medium is connected to the host; and a control unit mounting only a file selected by a predetermined method from the one or more files recognized by the file manager module to the host.

The file manager module may recognize the one or more files by reading file information corresponding to the one or more files stored in the removable storage medium in a state in which the removable storage medium is not mounted to the host.

The file manager module may directly access an area in which the file information is stored.

The control unit may include a selection module displaying file information of the one or more files recognized by the file manager module, and selecting the selected file based on a user input signal input based on the displayed file information.

The control unit may include a selection module having previously-stored information about an authorized file to be mounted to the host, and selecting the selected file corresponding to the information about the authorized file.

The information about the authorized file may include authentication information of the authorized file. The control unit may further include an authentication module for mounting the selected file only when the selected file corresponds to the authentication information.

The control unit may include a mounting module creating a virtual drive containing the selected file, and mounting the created virtual drive to the host.

According to another aspect of the present invention, provided is a removable storage medium security system provided in a host including: a file manager module recognizing one or more files stored in a removable storage medium when the removable storage medium is connected to the host; a selection module selecting a file from the one or more files based on previously-stored information about an authorized file; an authentication module determining whether or not the selected file selected by the selection module corresponds to previously-stored authentication information; and a mounting module mounting the selected file authenticated by the authentication module to the host in a state in which the selected file is contained in a virtual drive.

According to a further aspect of the present invention, provided is a removable storage medium security method including: recognizing, at a removable storage medium security system, one or more files stored in a removable storage medium when the removable storage medium is connected to a host; and mounting, at the removable storage medium security system, only a file selected by a predetermined method from the recognized one or more files to the host.

The step of recognizing, at the removable storage medium security system, the one or more files stored in the removable storage medium may include recognizing the one or more files by reading file information corresponding to the one or more files stored in the removable storage medium in a state in which the removable storage medium is not mounted to the host.

The step recognizing the one or more files by reading the file information corresponding to the one or more files stored in the removable storage medium may include directly accessing, at the removable storage medium security system, an area of the removable storage medium in which the file information is stored.

The removable storage medium security method may further include: displaying, at the removable storage medium security system, file information of the recognized one or more files to the host; and receiving a user input signal based on the displayed information. The step of mounting only the file selected by the predetermined method from the one or more files to the host may include mounting only the file selected based on the user input signal.

The removable storage medium security method may further include: previously storing, at the removable storage medium security system, information about an authorized file to be mounted to the host. The step of mounting only the file selected by the predetermined method from the one or more files to the host may include mounting only the selected file corresponding to the information about the authorized file to the host.

The information about the authorized file may include authentication information of the authorized file. The step of mounting only the file selected by the predetermined method from the one or more files to the host may include: determining whether or not the selected file corresponds to the authentication information; and only when the selected file is determined to correspond to the authentication information, mounting, at the removable storage medium security system, the selected file to the host.

The step of mounting only the file selected by the predetermined method from the one or more files to the host may include: creating, at the removable storage medium security system, a virtual drive containing the selected file; and mounting the created virtual drive to the host.

According to a further another aspect of the present invention, provided is a removable storage medium security method including: recognizing, at a removable storage medium security system, one or more files stored in a removable storage medium when the removable storage medium is connected to a host; selecting, at the removable storage medium security system, a file to be mounted from the one or more files based on previously-stored information about an authorized file; authenticating, at the removable storage medium security system, whether or not the selected file selected by the selection module corresponds to previously-stored authentication information; and when the selected file is authenticated to correspond to the previously-stored authentication information, mounting the authenticated selected file to the host in a state in which the selected file is contained in a virtual drive.

According to a yet another aspect of the present invention, provided is a computer readable recording medium in which a program for carrying out the above-described method is recorded.

### Advantageous Effects

According to the technical features of the present invention, even in the case in which a removable storage medium is connected to a host, the removable storage medium itself is not mounted to the host, but only a predetermined file selected from files stored in the removable storage medium is mounted to the host. It is therefore possible to prevent the host from being affected by data stored in the removable storage medium except for the selected files.

In particular, even in the case in which an unknown malicious file or the like is stored in the removable storage medium, it is possible to prevent the malicious file from being mounted to the host, thereby preventing the host from being infected by the malicious file. For example, it is possible to prevent a malicious file (e.g. a worm) located in a hidden file or a boot sector of the removable storage medium from affecting the host.

In addition, a file selected to be mounted to the host can be mounted to the host only after being authenticated the same as an authenticated original file. It is therefore possible to prevent a malicious file forged or altered from the selected file from being mounted to the host.

### DESCRIPTION OF DRAWINGS

For better understanding of the drawings referred to in the detailed description of the present invention, a brief description is given to the appended drawings, in which:

FIG. 1 illustrates an environment to which a removable storage medium security system according to an exemplary embodiment of the present invention is applied;

FIG. 2 schematically illustrates the configuration of the removable storage medium security system according to an exemplary embodiment of the present invention;

FIG. 3 is a schematic flowchart illustrating a removable storage medium security method according to an exemplary embodiment of the present invention;

FIG. 4 illustrates a method by which the removable storage medium security system according to an exemplary embodiment of the present invention recognizes files stored in a removable storage medium before the removable storage medium is mounted;

FIG. 5 illustrates a case in which a selected file is selected from files stored in a removable storage medium according to an exemplary embodiment of the present invention; and

FIG. 6 illustrates an example of a device mounted to a host according to an exemplary embodiment of the present invention.

### MODE FOR INVENTION

The present invention, advantages associated with the operation of the present invention and objects that are realized by the practice of the present invention will be apparent from the accompanying drawings which illustrate exemplary embodiments of the present invention and the detailed description of the present invention which are illustrated in the drawings.

Herein, it will be understood that, when an element is referred to as “transmitting” data to another element, the element not only can directly transmit the data to another element but also indirectly transmit the data to another element via at least one intervening element.

In contrast, when an element is referred to as “directly transmitting” data to another element, the element can transmit the data to another element without an intervening element.

The present invention will now be described more fully hereinafter with reference to the accompanying drawings, in which exemplary embodiments thereof are shown. Reference should be made to the drawings, in which the same reference numerals are used throughout the different drawings to designate the same components.

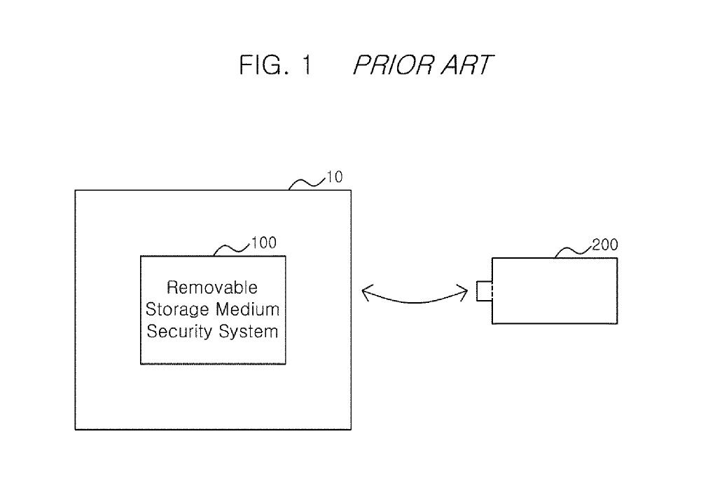

FIG. 1 illustrates an environment to which a removable storage medium security system 100 according to an exemplary embodiment of the present invention is applied.

Referring to FIG. 1, the removable storage medium security system 100 according to this embodiment may be provided in a host 10 to embody the technical features of the present invention. The host 10 may be connected to a removable storage medium 200. The removable storage medium 200 may be defined as any type of data storage medium that the host 10 can recognize when the removable storage medium 200 is connected to the host 10. Although the removable storage medium 200 will be described herein as being a universal serial bus (USB) data storage medium for the sake of convenience, the present invention is not limited thereto.

When the removable storage medium 200 is connected to the host 10, the host 10 can recognize that the removable storage medium 200 is connected thereto. It is possible to recognize whether or not the removable storage medium 200 is connected to the host 10 using an interface provided in the host 10 and a piece of software for operating the interface. Although the interface may be, for example, a USB interface, this is not intended to be limiting. In addition, the software may a device driver for operating the USB interface.

According to an alternative embodiment, the removable storage medium security system 100 may include an element for recognizing whether or not the removable storage medium 200 is connected to, for example, the host 10. This element may be installed in the host 10. In any cases, when the removable storage medium 200 is connected to the host 10, the removable storage medium 200 can recognize the connection of the removable storage medium 200 to the host 10 in a direct manner or an indirect manner via the host 10.

The removable storage medium security system 100 can control the host 10 such that at least a part of files stored in the removable storage medium 200 is selectively mounted to the host 10 instead of allowing the removable storage medium 200 itself to be mounted to the host 10. Herein, the mounting of only the selected file may indicate that a device (drive) in which only the selected file is located is mounted to the host 10. In addition, the presence of only the selected file may indicate the presence of the selected file, file information (e.g. directory information) corresponding to the selected file, and/or a file system for the selected file. Therefore, it should not be understood to a person skilled in the art to which the present invention pertains that there is no other data than the selected file.

The removable storage medium security system 100 is required to recognize one or more files stored in the removable storage medium 200 in the state in which the removable storage medium 200 is not mounted to the host 10 in order to mount only the selected file to the host 10. This technical feature can be realized by the removable storage medium security system 100 directly accessing a predetermined area of the removable storage medium 200 in the state in which the removable storage medium 200 is not mounted to the host 10. The direct access may indicate that the removable storage medium security system 100 directly accesses the removable storage medium 200 instead of that the removable storage medium 200 requests an operating system (OS) installed in the host 10 for an access to the removable storage medium 200.

Consequently, the removable storage medium security system 100 can recognize the one or more files stored in the removable storage medium 200 by directly accessing the predetermined area of the removable storage medium 200 even in the state in which the removable storage medium 200 is not mounted to the host 10 by directly accessing raw data stored in the removable storage medium 200.

In the meantime, the recognition of the one or more files may not indicate ability to read the one or more files. That is, the recognition of the one or more files may indicate determining whether or not the one or more files are located in the removable storage medium 200, since the technical features of the present invention require only to find what file is stored in the removable storage medium 200. In other words, the recognition of the one or more files stored in the removable storage medium 200 may indicate recognizing what file is located in the removable storage medium 200 and recognizing identification information of the one or more files, such as a file name, with which the one or more files can be identified individually. The identification information with which the one or more files can be identified individually will be defined herein as file information.

The removable storage medium security system 100 can recognize information about the one or more files by directly accessing the predetermined area of the removable storage medium 200. The predetermined area that the removable storage medium security system 100 accesses may vary depending on a file system with which the removable storage medium 200 is formatted. If necessary, the removable storage medium security system 100 may determine the type of the file system and directly select the area to access in an adaptive manner based on the result of the determination. In any cases, the predetermined area that the removable storage medium security system 100 accesses may include an area in which the information about the one or more files is stored in the removable storage medium 200.

When the one or more files are recognized by the removable storage medium security system 100, the removable storage medium security system 100 can specify the selected file to be mounted. The selected file can be specified by a user (or a manager) who uses the host 10, or can be specified automatically based on a predetermined piece of information stored in the removable storage medium security system 100. The information for specifying the selected file may include information about a file previously-authorized to be mounted to the host 10. Specifically, manifest information including a list of files mountable to the host 10 may be previously stored in the removable storage medium security system 100. The manifest information may be previously stored in the removable storage medium security system 100 by a developer or a distributer of the removable storage medium security system 100. In addition, the manifest information may include the file information of a predetermined file for the update of the manifest information. Therefore, the removable storage medium security system 100 may be configured to mount the file for the update of the manifest information to the host 10.

When the selected file is specified as above, the removable storage medium security system 100 may mount a device including the selected file to the host 10. Then, the host 10 can access only the selected file, and the host 10 is not influenced by the other files stored in the removable storage medium 200 except for the selected file since the device does not include any one of the other files. The device may be a virtual drive designed according to the technical features of the present invention. Therefore, when the removable storage medium 200 is connected to the host 10, the removable storage medium 200 is not mounted to the host, but the virtual drive including only a previously-authorized safe file, i.e. the selected file, is mounted to the host 10, whereby the host 10 can be safely protected. According to an alternative embodiment, the removable storage medium security system 100 can mount only a part of the removable storage medium 200 to the host 10 after changing the data storage state of the removable storage medium 200 to a predetermined mode. The latter case may spend more time and resources since the data storage state of the removable storage medium 200 must be changed in the state in which the removable storage medium 200 is not mounted to the host 10. However, this alternative can also embody the technical features of the present invention allowing only the selected file to be mounted.

The “host 10” may be defined as being any type of data processing device to which the removable storage medium 200 can be connected. The host 10 may be, for example, a desktop computer, a notebook computer, a tablet computer or a mobile terminal of a user, or a web server that provides web services. The host 10 may also be an independent data processing device isolated from the external network or a data processing device that establishes an independent network. For example, the host 10 may be implemented as a power control system, a control system for a nuclear power plant, a system included in a national backbone network, such as a supervisory control and data acquisition (SCADA) network, or the like.

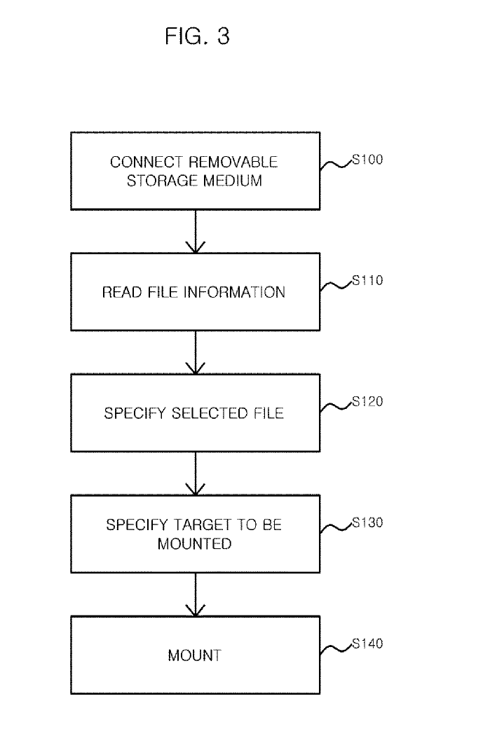

A security method using the above-described removable storage medium security system 100 can be schematically briefed as in FIG. 3.

FIG. 3 is a schematic flowchart illustrating a removable storage medium security method according to an exemplary embodiment of the present invention.

Referring to FIG. 3, when the removable storage medium 200 is connected to the host 10 (S100), the removable storage medium security system 100 reads information about files stored in the removable storage medium 200 (S110).

Then, at least a part of the files stored in the removable storage medium 200 is selected by the removable storage medium security system 100. That is, the selected file is specified (S120).

When the selected file is specified, a device for mounting the selected file to the host 10, i.e. a mounting target, is specified (S130). For example, a virtual drive including the selected file may be created as will be described later, or a new partition including only the selected file may be created in the removable storage medium 200.

Thereafter, the removable storage medium security system 100 mounts the mounting target, i.e. the device including only the selected file, to the host 10 (S140), thereby preventing the host 10 from being influenced by any file or codes stored in the removable storage medium 200 except for the selected file.

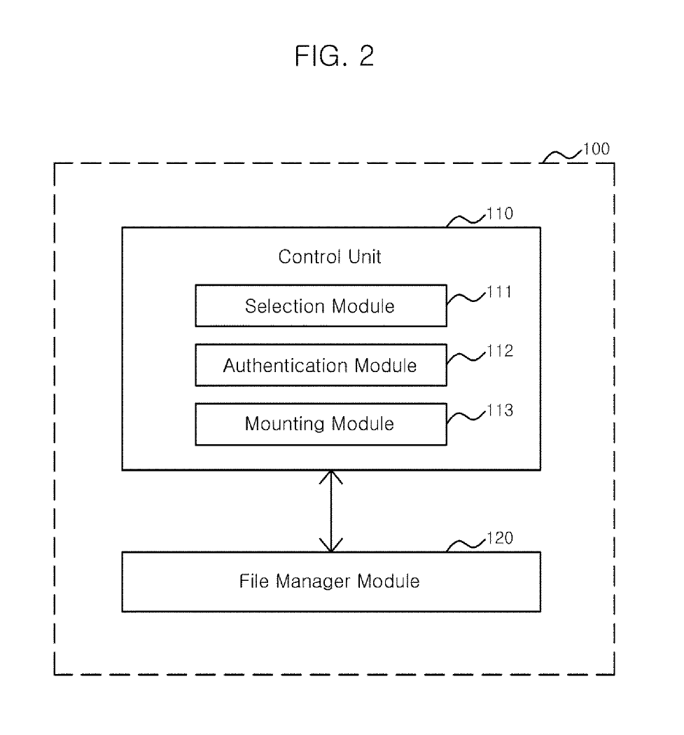

The technical features of the present invention will be described in more detail below with reference to FIG. 2 to FIG. 6.

FIG. 2 schematically illustrates the configuration of the removable storage medium security system according to an exemplary embodiment of the present invention.

Referring to FIG. 2, the removable storage medium security system 100 according to this embodiment includes a control unit 110 and a file manager module 120. The control unit 110 includes a selection module 111, an authentication module 112 and/or a mounting module 113.

The control unit 110 can control the functions and/or the resources of the components of the removable storage medium security system 100 (e.g. the selection module 111, the authentication module 112, the mount module 113 and the file manager module 120) in order to embody the technical features of the present invention. The control unit 110 may be embodied by a systematic combination of a central processing unit (CPU) (or a processor) in the removable storage medium security system 100 and software codes defined to enable the control unit 110 to operate.

Herein, the term “section” or “module” may refer to a functional and/or structural combination of hardware for embodying the technical features of the present invention and software for enabling the hardware to operate. For example, the “section” or the “module” may mean a logical unit of codes and hardware resources for executing the codes. It is apparent to a person skilled in the art to which the present invention pertains that the “section” or the “module” does not necessarily indicate either physically-connected codes or one type of hardware.

In some implementations, the removable storage medium security system 100 may be disposed not only in a single physical unit, but also in a plurality of physical units. That is, the host 10 is not necessarily implemented as a single physical unit. The host 10 may be a system in which a plurality of physical units are systematically combined through wired/wireless networks. The removable storage medium security system 100 may be duplicated or distributed in the plurality of physical units.

The file manager module 120 can recognize the one or more files stored in the removable storage medium 200. For this, when the removable storage medium 200 is connected to the host 10, the file manager module 120 can read file information of the one or more files in the state in which the removable storage medium 200 is not mounted to the host 10. The file manager module 120 can be notified from a predetermined device (e.g. a device driver) disposed in the host 10 that the removable storage medium 200 has been connected to the host 10.

If the host 10 is configured to automatically mount the removable storage medium 200 thereto when the removable storage medium 200 is connected thereto, the control unit 110 may be configured to control a removable storage medium mounting configuration (e.g. a storage driver), i.e. a configuration for mounting the removable storage medium 200 to the host 10 (e.g. a storage driver), such that the removable storage medium 200 is not automatically mounted. Alternatively, the removable storage medium security system 100 may be disposed in the host 10 and may include a configuration for mounting the removable storage medium 200 to the host 10 in order to embody the technical features of the present invention.

In any case, the file manager module 120 can read the file information of the one or more files in the state in which the removable storage medium 200 is not mounted to the host 10, and for this purpose, can directly access the area in which the file information is stored. That is, the file manager module 120 can access the area without via the OS of the host 10. According to the scheme in which the file manager module 120 directly accesses the area, it is possible to directly access a physical drive of the removable storage medium 200 by a file-opening operation or the like and extract information about the area from the physical drive. In some implementations, it is possible selectively open the area. It is also possible to access the file information stored in the area using a known solution (or an application) able to directly access the physical drive. It is apparent to a person skilled in the art to which the present invention pertains that a variety of embodiments for directly accessing the file information stored in the area is possible.

The area in which the file information is stored may vary depending on the type of a file system that the removable storage medium 200 uses. Herein, for the sake of convenience, it will be described by way of example that the removable storage medium 200 is a USB storage medium and the removable storage medium 200 is formatted with the file allocation table (FAT) system. However, it is apparent to a person skilled in the art to which the present invention pertains that the area in which the file information is stored may be defined according to the type of the file system of the removable storage medium 200, and that the technical features of the present invention may be embodied by directly accessing the area in which the file information is stored.

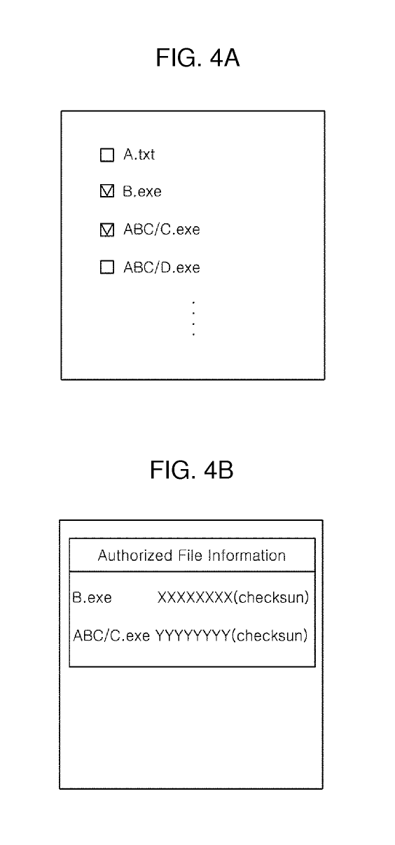

An example in which the removable storage medium 200 uses the FAT system is illustrated in FIG. 4.

FIG. 4 illustrates a method by which the removable storage medium security system according to an exemplary embodiment of the present invention recognizes files stored in a removable storage medium before the removable storage medium is mounted.

Referring to FIG. 4, the removable storage medium 200 is formatted with the FAT system. The removable storage medium 200 may be divided into one or more partitions (e.g. Partition 1 and Partition 2). Each partition may be formatted with the FAT system.

The FAT system may include a reserved area, an FAT area, and a data area. The data area may be divided again into a directory area and a file area. In some implementations, the directory area may include a fixed root directory area (e.g. in the case of FAT 16) or not. In most cases, the root directly area may be located right after the FAT area. The directory area may be fixed, and may be located in a cluster of the data area.

Therefore, the file manager module 120 can read the file information of the one or more files stored in the removable storage medium 200 by specifying and subsequently reading the area in which the directory is located by referring to the FAT stored in the FAT area. The file name, the file properties (e.g. reading/writing properties and hiding property), the time of creation, the file size, and the like of the one or more files may be defined in the directory. At least one piece of information defined in the directory may included in the file information. Therefore, the file manager module 120 may acquire the file information of the one or more files stored in the removable storage medium 200 by reading only the information stored in the directory.

Returning to FIG. 2, when the file information of the one or more files stored in the removable storage medium 200 is acquired, the control unit 110 can mount only a file selected from the one or more files to the host 10.

For this, the control unit 110 includes the selection module 111. As described above, a user (or a manager) of the host 10 may cause the selection module 111 to select the selected file. Alternatively, the selected file may be automatically selected based on manifest information that is previously stored. The manifest information may include information about files that can be mounted to the host 10, i.e. authenticated files.

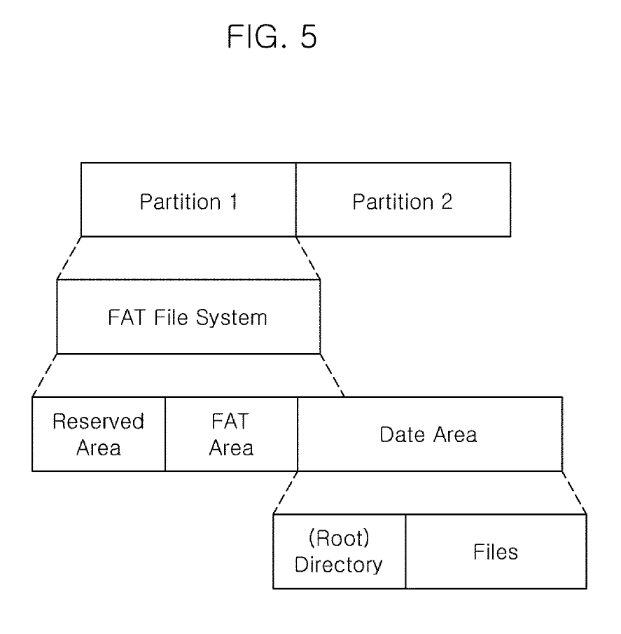

This example is illustrated in FIG. 5.

FIG. 5 illustrates a case in which a selected file is selected from files stored in a removable storage medium according to an exemplary embodiment of the present invention.

First, referring to FIG. 5(a), the selection module 111 may display the file information (e.g. the file name) of the one or more files, as illustrated in FIG. 5(a), based on the file information of the one or more files recognized by the file manager module 120. The selection module 111 may simply list up the file information of the one or more files, as illustrated in FIG. 5(a), or may provide the file information on a tree structure (e.g. a user interface (UI) provided from the Windows Explorer) corresponding to the directory structure stored in the removable storage medium 200. Predetermined UIs (e.g. a check box) may be further provided, allowing the user to select each of the one or more files.

Then, at least a part of the one or more files may be selected by the user. Information about the selected file may be received by the selection module 111. The selection module 111 may specify the selected file as a target to be mounted.

FIG. 5(a) illustrates the case in which at least four files (e.g. A.txt, B.exe, C.exe located in an ABC folder, and D.exe located in the ABC folder) are located in the removable storage medium 200, and the second and third files (B.exe and C.exe) are selected from the at least four files.

Referring to FIG. 5(b), the selection module 111 may previously store the manifest information. The manifest information may include information about files to be mounted to the host 10. In some implementations, the manifest information may include authentication information. The authentication information may be defined as including all types of information, such as a checksum and a fingerprint, available for determining whether or not the authorized file is forged or altered. In some implementations, the manifest information can be encrypted by a predetermined method before being stored in the selection module 111, and the manifest information stored in the selection module 111 cannot be decrypted until it satisfies predetermined conditions. For example, the predetermined conditions may be a case in which the user must input a predetermined authentication key or a case in which a system having a decryption key must be connected to the host 10. It is therefore possible to prevent the manifest information from being forged or altered by malicious attacks.

For example, when the manifest information includes information about only the second file “B.exe” and the third file “C.exe”, the selection module 111 may specify only the files “B.exe” and “C.exe” of the one or more files (e.g. A.txt, B.exe, C.exe and D.exe) corresponding to the manifest information as targets to be mounted.

When the targets to be mounted, i.e. the selected files, are specified, the mounting module 113 can mount a predetermined device containing the selected files. In some implementations, the authentication module 112 of the control unit 110 may authenticate the selected files, and mount only the selected files to the host 10 in the state in which the authenticated selected files are contained in the device.

The authentication module 112 may authenticate the selected file using authentication information included in the manifest information. For the authentication using the authentication information, it is possible to directly access and read all or part of the selected files. A variety of method of finding a forged or altered file may be used in the authentication of the selected files. Such methods may use, for example, a checksum, a cyclic redundancy check (CRC) or a fingerprint. The manifest information may include authentication information, such as checksum information or fingerprint information, for such authentication methods. In some implementations, the authentication information may be stored in the authentication module 112 separate from the manifest information.

The authenticated selected files can be mounted to the host 10 in the state in which the files are contained in a device. In an example, the device may be a virtual drive established by the mounting module 113 of the control unit 110. Alternatively, this device may be at least a part of the removable storage medium 200.

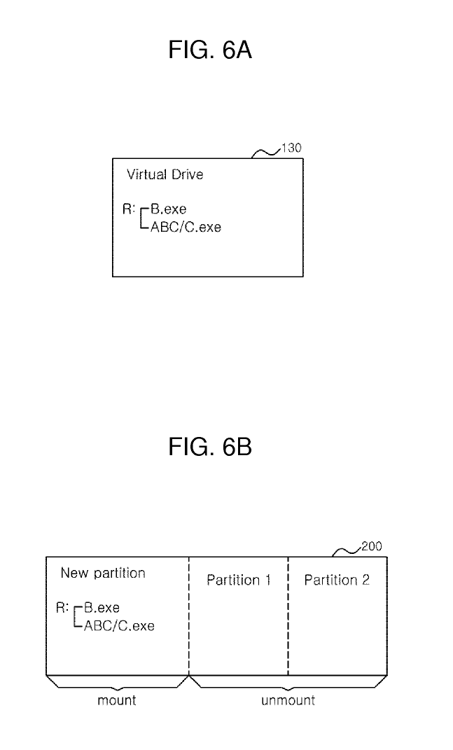

This example is illustrated in FIG. 6.

FIG. 6 illustrates an example of a device mounted to a host according to an exemplary embodiment of the present invention.

First, FIG. 6(a) illustrates a case in which the virtual drive is mounted. The mounting module 113 may receive information about a selected file, and mount only the selected files to the host 10 in the state in which the selected file is contained in the virtual drive. For this, the mounting module 113 may create a file corresponding to the virtual drive and mount the created file to the host 10 such that the host 10 recognizes the file as a drive. Of course, a plurality of the files may be created by the mounting module 113. The virtual drive may be implemented as a file system the same as the file system of the host 10 or the removable storage medium 200.

The removable storage medium security system 100 may previously receive the selected file from the removable storage medium 200 by direct access. The selected file may be previously received when the authentication module 112 is authenticated, or may be received by the mounting module 113.

Consequently, when the removable storage medium 200 is connected to the host 10, only an allowed safe file can be mounted to the host 10 through the virtual drive, whereby the host 10 can be safely protected.

Referring to FIG. 6(b), the mounting module 113 can mount at least a part of the removable storage medium 200. At this time, the mounting module 113 can create a predetermined area (partition) in the removable storage medium 200, only a file selected by the selection module 111 being located in the predetermined area. According to an implementation, the mounting module 113 can delete all data except the selected file by direct access and subsequently selectively mount the partition in which the selected file is located to the host 10. Alternatively, it is possible to create a new partition in which only the selected file is located and mount the created partition to the host 10.

It is possible to perform the operation of writing dummy data in the other areas except the area in which the selected file is stored by direct access in order to delete all data except the selected file.

In the case of mounting only the partial area of the removable storage medium 200 in which only the selected file is located as above, there are the following problems. The data storage state of the removable storage medium 200 is changed. When the removable storage medium 200 is a mass storage medium, a long time may be required to, for example, create a partition or delete data. However, the security effect is still better than the related-art inspection using an antivirus program.

In addition to the technical features of the present invention as above, a technical feature of determining whether or not the removable storage medium 200 is an authorized removable storage medium may be further applied in order to protect the host 10. For this, identification information for the authorized removable storage medium 200 may be previously stored in the removable storage medium security system 100. For example, the identification information of the removable storage medium 200 may be previously stored in the removable storage medium security system 100, or the technical features of the present invention may be realized through only the removable storage medium 200 that is authorized by a variety of methods.

The removable storage medium 200 may be implemented as any type of removable storage medium. In some implementations, the removable storage medium 200 may include a dedicated hardware chip available for a specific host. The hardware chip may be a chip functioning to authenticate that the removable storage medium 200 is available for the specific host. In some implementations, the removable storage medium 200 may be connected to a host by means of a connector including the hardware chip.

The removable storage medium security method according to an embodiment of the present invention may be embodied as computer readable codes stored in a computer readable recording medium. The computer readable recording medium includes all sorts of record devices in which data readable by a computer system are stored. Examples of the computer readable recording medium include read only memory (ROM), random access memory (RAM), compact disc read only memory (CD-ROM), a magnetic tape, a hard disk, a floppy disk, an optical data storage device and the like. Further, the recording medium may be implemented in the form of a carrier wave (e.g. Internet transmission). In addition, the computer readable recording medium may be distributed to computer systems on the network, in which the computer readable codes are stored and executed in a decentralized fashion. In addition, functional programs, codes and code segments for embodying the present invention can be easily construed by programmers having ordinary skill in the art to which the present invention pertains.

While the present invention has been described with reference to the certain exemplary embodiments shown in the drawings, it will be understood by a person skilled in the art that various modifications and equivalent other embodiments may be made therefrom. Therefore, the true scope of the present invention shall be defined by the concept of the appended claims.

### INDUSTRIAL APPLICABILITY

The present invention is applicable to the security of a system having a USB interface.

1. A removable storage medium security system provided in a host comprising:
a file manager module recognizing one or more files stored in a removable storage medium when the removable storage medium is connected to the host; and
a control unit mounting only a file selected by a predetermined method from the one or more files recognized by the file manager module to the host.

2. The removable storage medium security system according to claim 1, wherein the file manager module recognizes the one or more files by reading file information corresponding to the one or more files stored in the removable storage medium in a state in which the removable storage medium is not mounted to the host.

3. The removable storage medium security system according to claim 2, wherein the file manager module directly accesses an area in which the file information is stored.

4. The removable storage medium security system according to claim 1, wherein the control unit comprises a selection module displaying file information of the one or more files recognized by the file manager module, and selecting the selected file based on a user input signal input based on the displayed file information.

5. The removable storage medium security system according to claim 1, wherein the control unit comprises a selection module having previously-stored information about an authorized file to be mounted to the host, and selecting the selected file corresponding to the information about the authorized file.

6. The removable storage medium security system according to claim 5, wherein
the information about the authorized file comprises authentication information of the authorized file, and
the control unit further comprises an authentication module for mounting the selected file only when the selected file corresponds to the authentication information.

7. The removable storage medium security system according to claim 1, wherein the control unit comprises a mounting module creating a virtual drive containing the selected file, and mounting the created virtual drive to the host.

8. A removable storage medium security system provided in a host comprising:
a file manager module recognizing one or more files stored in a removable storage medium when the removable storage medium is connected to the host;
a selection module selecting a file from the one or more files based on previously-stored information about an authorized file;
an authentication module determining whether or not the selected file selected by the selection module corresponds to previously-stored authentication information; and
a mounting module mounting the selected file authenticated by the authentication module to the host in a state in which the selected file is contained in a virtual drive.

9. A removable storage medium security method comprising:
recognizing, at a removable storage medium security system, one or more files stored in a removable storage medium when the removable storage medium is connected to a host; and
mounting, at the removable storage medium security system, only a file selected by a predetermined method from the recognized one or more files to the host.

10. The removable storage medium security method according to claim 9, wherein recognizing, at the removable storage medium security system, the one or more files stored in the removable storage medium comprises recognizing the one or more files by reading file info ration corresponding to the one or more files stored in the removable storage medium in a state in which the removable storage medium is not mounted to the host.

11. The removable storage medium security method according to claim 10, wherein recognizing the one or more files by reading the file information corresponding to the one or more files stored in the removable storage medium comprises directly accessing, at the removable storage medium security system, an area of the removable storage medium in which the file information is stored.

12. The removable storage medium security method according to claim 9, further comprising:
displaying, at the removable storage medium security system, file information of the recognized one or more files to the host; and
receiving a user input signal based on the displayed information,
wherein mounting only the file selected by the predetermined method from the one or more files to the host comprises mounting only the file selected based on the user input signal.

13. The removable storage medium security method according to claim 9, further comprising previously storing, at the removable storage medium security system, information about an authorized file to be mounted to the host,
wherein mounting only the file selected by the predetermined method from the one or more files to the host comprises mounting only the selected file corresponding to the information about the authorized file to the host.

14. The removable storage medium security method according to claim 13, wherein
the information about the authorized file comprises authentication information of the authorized file, and
mounting only the file selected by the predetermined method from the one or more files to the host comprises:
determining whether or not the selected file corresponds to the authentication information; and
only when the selected file is determined to correspond to the authentication information, mounting, at the removable storage medium security system, the selected file to the host.

15. The removable storage medium security method according to claim 9, wherein mounting only the file selected by the predetermined method from the one or more files to the host comprises:
creating, at the removable storage medium security system, a virtual drive containing the selected file; and
mounting the created virtual drive to the host.

16. A removable storage medium security method comprising:
recognizing, at a removable storage medium security system, one or more files stored in a removable storage medium when the removable storage medium is connected to a host;
selecting, at the removable storage medium security system, a file to be mounted from the one or more files based on previously-stored information about an authorized file;
authenticating, at the removable storage medium security system, whether or not the selected file selected by the selection module corresponds to previously-stored authentication information; and
when the selected file is authenticated to correspond to the previously-stored authentication information, mounting the authenticated selected file to the host in a state in which the selected file is contained in a virtual drive.

17. A computer readable recording medium in which a program for carrying out the method as claimed in claim 9 is recorded.

18. A computer readable recording medium in which a program for carrying out the method as claimed in claim 16 is recorded.
